(19) United States
(12) Patent Application Publication
(10) Pub. No.: US 2024/0279094 A1
(43) Pub. Date: Aug. 22, 2024

(54) CONTROL OF OZONE DOSING WITH BIO-ELECTROCHEMICAL SENSOR

(71) Applicant: BL TECHNOLOGIES, INC., Minnetonka, MN (US)

(72) Inventors: Didier PERRIN, Paris (FR); Adriano VIEIRA, Ashland, VA (US); Joel Alexander CITULSKI, Oakville (CA); Julien REUNGOAT, North Chesterfiled, VA (US)

(21) Appl. No.: 18/569,582

(22) PCT Filed: Jun. 16, 2022
(86) PCT No.: PCT/US22/33766

§ 371 Date: Dec. 12, 2023

(30) Foreign Application Priority Data
Jun. 17, 2021 (FR) 2106452

(51) Int. Cl. C02F 3/00; C02F 3/06

(52) U.S. Cl. CPC C02F 3/006; C02F 3/06; C02F 2209/001; C02F 2209/003; C02F 2209/006; C02F 2209/20; C02F 2209/23; C02F 2209/36; C02F 2305/023

(57) ABSTRACT

A water treatment system has an ozonation unit (12), a biological sensor (16) and optionally a biological treatment unit (14). The biological sensor (16) measures the biodegradability of organic contaminants after ozonation. The biological sensor (16) may be a bio-electrochemical sensor that produces an electrical signal related to the metabolic activity of bacteria on an electrode of the sensor. The biological sensor (16) may be connected to a controller (18) adapted to adjust one or more operating parameters of the ozonation unit (12) or the biological treatment unit (16) or both. A method of treating water, and a method of controlling a water treatment process, using a biological sensor to measure the biodegradability of water are further described. The measurement may be used to adjust an upstream ozonation process or a downstream biological treatment process. The systems and methods may be used to remove refractory organic compounds or organic micro-pollutants from secondary or tertiary effluent from a municipal or industrial wastewater plant.

### RELATED APPLICATIONS

This application claims the benefit of French patent application No. 2106452, filed on Jun. 17, 2021, which is incorporated herein by reference.

### FIELD

This specification relates to wastewater treatment, including control of ozone dosing in a wastewater treatment system, optionally in combination with biological treatment.

### BACKGROUND

U.S. Pat. No. 10,287,182, Regulating Method for a Water Treatment Installation Using Measured Parameters and Control of an Ozonisation Device, describes a method for controlling a water treatment installation having an ozonation stage, a transfer stage, and a biological filter. The method includes controlling the amount of ozone supplied in relation to measurements of contaminant concentration in an influent, water in the transfer stage and an effluent. The contaminant concentration is measured using a fluorescence sensor or a UV/Vis sensor.

### INTRODUCTION

The following introduction is intended to introduce the reader to the invention and the detailed description to follow, but not to limit or define the claims.

This specification describes a water treatment system with an ozonation unit (optionally called an ozone contactor) and a biological sensor (optionally called a biosensor). The biological sensor is adapted to measure a metabolic parameter related to the extent to which organic contaminants in a water treatment process stream have been made biodegradable after contact with ozone. For example, the biological sensor may produce or enable a measurement or signal related to the metabolic activity, for example carbon bio-degradation (CED) or carbon consumption rate (CCR) of a population of bacteria. In some examples, the biological sensor is a bio-electrochemical sensor adapted to measure metabolic activity, for example a carbon consumption rate by producing an electrical signal related to the metabolic activity of bacteria on an electrode of the sensor. The biological sensor is optionally connected to a controller adapted to adjust the rate of ozone delivery to the wastewater. In some examples, a biological treatment unit, for example a biologically active filter (BAF), is provided downstream of the ozonation unit. Optionally, a measurement or signal from the biosensor may be used to adjust an operating parameter of the biological treatment unit.

The specification also describes a method of treating water, and a method of controlling a water treatment process, using a biological sensor. The biological sensor is in contact with water that has been contacted with ozone. The biological sensor measures the extent to which organic contaminants in the water have become biodegradable. For example, the biological sensor may measure the metabolic activity, for example the carbon consumption rate, of organisms exposed to the ozonated water. In some examples, the biological sensor is a bio-electrochemical sensor, which provides an electrical signal corresponding to the metabolic activity of a population of bacteria on an electrode of the biosensor. Optionally, a voltage and/or current may be delivered across an electrode pair of the biosensor. A measurement or signal from the biosensor is used to adjust the rate of ozone delivery to the wastewater. The contaminants in the wastewater may be biologically degraded after being contacted with ozone. For example, the wastewater may be treated in a biologically active filter (alternatively called a biological activated filter or a biological filter or a biofilter). Optionally, a measurement or signal from the biosensor may be used to adjust an operating parameter of the biological degradation process.

The systems and methods described herein are useful, among other examples, for treatment of secondary or tertiary effluent from a municipal or industrial wastewater treatment plant. The systems and methods help reduce the concentration of one or more refractory compounds or micro-pollutants prior to discharge of the treated effluent or direct or indirect re-use of the treated wastewater.

### BRIEF DESCRIPTION OF THE FIGURES

FIG. 1 is a schematic drawing of a wastewater treatment system and process flow diagram of a wastewater treatment process.

FIG. 2 is a schematic graph of total organic carbon (TOC) and carbon consumption rate over time for wastewater being treated in the wastewater treatment system or process of FIG. 1.

FIG. 3 illustrates a method of controlling O3 in a wastewater treatment system using biological sensors.

FIG. 4 is a schematic graph showing a relationship between a comparison, i.e. a ratio, of TOC effluent/TOC influent and metabolic activity, for example CCR.

FIG. 5 is a schematic graph of metabolic activity, for example CCR, as a function of the ratio of O3/TOC influent, wherein the ozone is an amount of ozone added to an ozone contactor.

### DETAILED DESCRIPTION

Systems and methods described herein use a biological sensor, for example a bio-electrochemical sensor, to control the operating conditions of a wastewater treatment system or process. The wastewater treatment system includes an ozonation unit and optionally a downstream biological treatment unit such as a biologically active filter. The wastewater treatment system is optionally located in a municipal or industrial wastewater treatment plant downstream of secondary- or tertiary-level treatment in the plant. The biological sensor is in contact with ozonated effluent, for example near or downstream of the end of the ozonation unit, or in an intermediate zone between the ozonation unit and the biological treatment unit or integrated in the biological treatment. For example, the biological sensor may be located above the media in the BAF or slightly embedded in the media, for example about 2 to about 3 inches below the top of the media. The biological sensor is for example, preferably downstream of a sodium bisulfite injection such as to avoid adverse effects of O3 neutralization on the biological sensor. The biological sensor measures, directly or indirectly, the biological availability of organic carbon compounds in the ozonated effluent. At least some of these biodegradable compounds are produced by ozonation of refractory organic compounds or micro-pollutants in the ozonation unit. In some examples, the biological sensor measures electron transport through a biofilm-impregnated electrode. The measurement of the rate of uptake of biodegradable compounds in real-time may allow for control of the ozonation unit. In an example, a sudden drop or increase in the rate of uptake of biodegradable compounds may indicate an operational issue. Operational issues may be related to the ozone dose or sudden variations in nutrients which may need to be adapted, for example by adapting BAF operations or controlling ozone dosage. Alternatively, or additionally, the measurement of the rate of uptake of biodegradable compounds in combination with an algorithm, optionally implemented by an operator or a computer, optionally based on historical data from the same or an analogous wastewater treatment plant, may allow for control of the ozonation unit. For example, the ozone injection rate in the ozone contactor may be controlled to provide one or more of: maximum concentration of easily biodegraded organic compounds; at least a minimum concentration of easily biodegraded organic compounds; and, optimal concentration of easily biodegraded organic compounds according to a function that includes one or more factors such as minimum conversion, electricity consumption, target water quality, ozone consumption and biological treatment factors. Increasing the biodegradability of contaminants can improve the performance of an optional downstream biological treatment unit. Optionally, one or more operating parameters of the biological treatment parameters can be adjusted based on the measurement provided by the biological sensor. Optionally, a second biological sensor may be provided in communication with influent wastewater such that a background concentration of easily biodegraded organic compounds may be distinguished from easily biodegraded organic compounds created by conversion of refractory compounds by way of ozonation.

Ozone generation in a wastewater treatment plant may be controlled using one or more relationships between TOC effluent, TOC influent, metabolic activity for example as determined by a biological sensor, and ozone. The relationships may be created, for example, by way of one or more of calculations, modeling or historical plant operating data. Historical data may be collected from one or more analogous plants, i.e. plants with an ozone contactor and a BAF. In some examples, historical data is collected from the same wastewater treatment plant that is being controlled to produce a site specific O₃ dosage control algorithm. The word “algorithm” is used herein to indicate a method involving steps, some or all of which are optionally implemented by way of a computer. In an example, a plant may be started with a predefined algorithm from a previous application in a similar plant or based on calculated or modeled relationships. Historical data comprising metabolic activity, for example CCR measurements, may be collected throughout the first months (i.e. 1-8 months) of operation and the algorithm may then be created or refined. Optionally, the algorithm may be further refined throughout, for example, the first year of operation of the plant or more based on the collected historical data. In an example, the algorithm may be continuously updated with data collected by one or more biological sensors and other relevant operational data in order to continue to refine the algorithm in a manner specific to the plant. The O₃ control algorithm is used in combination with real-time biological sensor readings to control ozone generation. Optionally other inputs, for example TOC or nitrogen data collected from the influent and/or a target effluent TOC, are also input to the algorithm.

Biological sensors measure one or more aspects of water based on a biological response to the one or more aspects. In some examples, a biosensor, optionally called a bioelectrochemical sensor, may be based on a microbial fuel cell or another bioelectrochemical system. A bioelectrochemical sensor may sense an electrical signal produced by electroactive microbes growing on an electrode of the sensor. An aspect of the signal may be related to a metabolic process of the microbes, which may in turn be related to one or more aspects of water in contact with the sensor. Optionally, a concentration of easily biodegradable compounds may be measured by a signal from the biological sensor that is related to, or interpreted as, a carbon consumption rate (CCR).

The systems and methods are described further below in the context of an example of a wastewater treatment system, although they can be used or adapted to other systems and methods. The exemplary system has an ozone contactor upstream of a biologically active filter. Systems of this type have been used to remove refractory chemical oxygen demand (COD), total organic carbon (TOC) or micro-pollutants from conventional municipal or industrial wastewater treatment plant effluents, for example activated sludge plants or membrane bioreactor (MBR) systems. In the municipal sector, an ozone contact unit and biologically active filter product combination is mainly applied for TOC and micro-pollutant removal before effluent discharge or in indirect- or direct-potable reuse (IPR/DPR) treatment schemes.

In the ozone contact and biologically active filtration system, each process step has its own objective. Ozonation transforms the refractory organic compounds into more biodegradable species while the biologically active filtration biodegrades the transformed organic compounds. From an operating expense (OPEX) perspective, the ozonation step represents a significant share, for example 80% or more, of the utilities costs of the combined system. The utilities costs are mainly electricity and oxygen. However, most ozonation systems are installed because the effluent from the upstream plant fails to meet a desired parameter, for example a regulated limit on TOC concentration. Accordingly, it is necessary to consume some utilities to reach a desired level of treatment.

Balancing the desire to reach a desired level of treatment with a desire to minimize the consumption of oxygen and electricity requires control towards optimization of the ozonation unit. Control of the ozonation unit may be implemented by adjusting the amount of ozone that is injected into the ozone contactor, optionally relative to the flow rate of water or unit volume of water treated. If insufficient ozone is injected in the ozone contactor, the biologically active filter will not remove enough organic compounds and the overall removal target, for example TOC concentration in the biologically active filter effluent, will not be reached. If too much ozone is injected in the ozone contactor, the consumption of ozone and electricity may be un-necessarily increased. In addition, excessive ozone may cause excessive transformation of organic compounds. This can in some cases create less-biodegradable species, thereby preventing the biologically active filter from working efficiently. An excess of ozone injected will also lead to increased OPEX and potentially to the formation of unwanted chemical byproducts. Accordingly, there is an optimum ozone dose injected in the ozone contactor for a) maximum conversion of refractory compounds by way of ozonation, b) maximum removal of refractory compounds in the combined (ozonation and biological treatment) product, c) minimization of the formation of unwanted byproducts, or d) minimum OPEX required to reach a target for conversion of refractory compounds by way of ozonation or in the combined product. Measurements from the biological sensor are used to control the ozonation unit or combined product to achieve one or more of these objectives.

Measurement of biodegradable species is typically done through biochemical oxygen demand (BOD) analysis. However, direct measurement of BOD production through the ozone contactor is impractical to control the optimum ozone dosage rate in real-time. Analysis of BOD may require several hours to several days, which is too slow for effective control of the ozonation process. In addition, readings for very low BOD levels (i.e. less than a few mg/I) cannot be achieved with enough accuracy to control the ozone dosage rate.

To solve the problem of BOD direct measurement, surrogates have been used like fluorescence or UV/Vis measurements. The transformation of some organic compounds from complex refractory molecules to simpler, more bioavailable molecules can be represented by changes in fluorescence measurement or UV absorption pre- and post-ozonation. However, only a fraction of the transformed organic compounds can be measured with fluorescence or UV/Vis measurements. Fluorescence or UV/Vis measurements provide no information on organic constituents that do not have a fluorescing or a UV-sensitive functional group, and UV absorption measurements may be subject to interference from non-organic UV-active species. Accordingly, this method can produce erroneous results when treating some wastewater streams. In addition, a fluorescence or UV/Vis parameter such as UV254 follows a smooth, continuously decreasing, curve as the water proceeds through a combined ozonation and biologically active filtration system. There is no clear definition of the optimum UV254 after ozonation that results in optimized combined system performance. Inline TOC measurements can provide the total concentration of all organic carbon species that are present in a sample, but do not provide insight into the changes of biodegradability of the organic compounds within the sample due to ozonation.

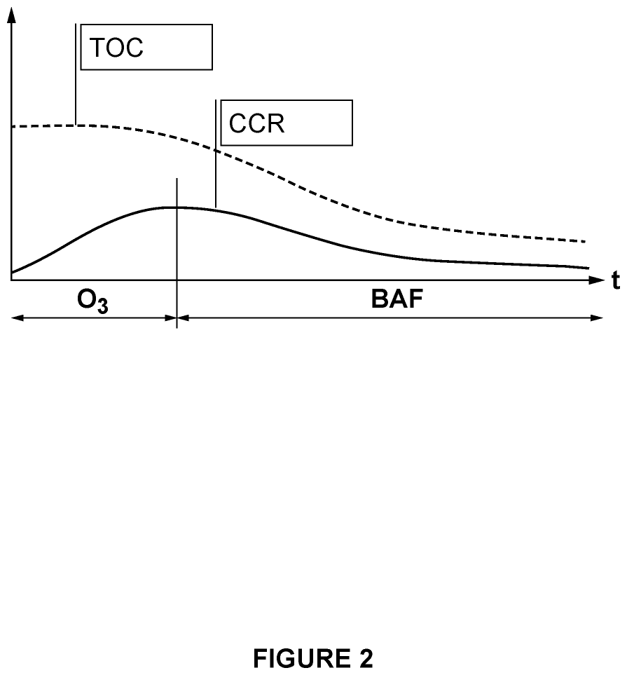

In a system with an ozone contactor, such as an ozone contactor and biologically active filter system, a biological sensor is installed downstream of the ozone contactor. Metabolic activity, such as biofilm growth or uptake of organic carbon, is detected by the sensor. The sensor generates a measurement or signal at a sufficient rate, i.e. at least once per hour, useful for controlling an aspect of the ozone contactor, for example the ozone dosage rate. In some examples, the biological sensor may be a bio-electrochemical sensor. A bio-electrochemical sensor may generate an essentially continuous or real-time digital signal, for example a signal that is updated every 10 minutes or less. Optionally, the presence of biological activity on the sensor generates a flow of electrons that is interpreted as a measurement of the carbon consumption rate (CCR). The CCR measurements are correlated with the biodegradability of contaminants in the water in contact with the sensor, which in turn is correlated with the extent to which refractory organics have become biodegradable after the ozonation step. Referring to FIG. 2, CCR increases during ozonation and decreases during any optional downstream biological treatment. A peak in CCR occurs at the end of the ozonation step, or between ozonation and biological treatment steps. Controlling ozone dosage so as to produce a maximum reading of CCR corresponds to the optimum ozone dosage rate in the ozone contactor for producing a non-refractory effluent. Alternatively, minimizing the ozone dosage such that CCR remains above a threshold, or within a desirable range, allows for a reduction in electricity and ozone consumption while meeting an effluent target, or providing desirable operating conditions in the biological treatment step, or both. A threshold or range of CCR may be selected based on one or more of: satisfying an effluent quality target optionally at minimum operating expense; the desired input to a downstream biological process; and an optimizing function that includes elements of effluent quality and operating cost. Alternatively, a system may be controlled to provide the maximum possible CCR.

An example of a commercially available bio-electrochemical sensor is the SENTRY™ sensor made by Island Water Technologies Inc. Examples of bio-electrochemical sensor are also described in US Patent Application Publications 2020/0283314, 2020/0003754 and 2014/0353170, all of which are incorporated herein by reference. Alternatively, other forms of biosensors may be used. For example, the production of biodegradable species after ozonation can be measured using a biofilm, or biofilm thickness, monitoring instrument.

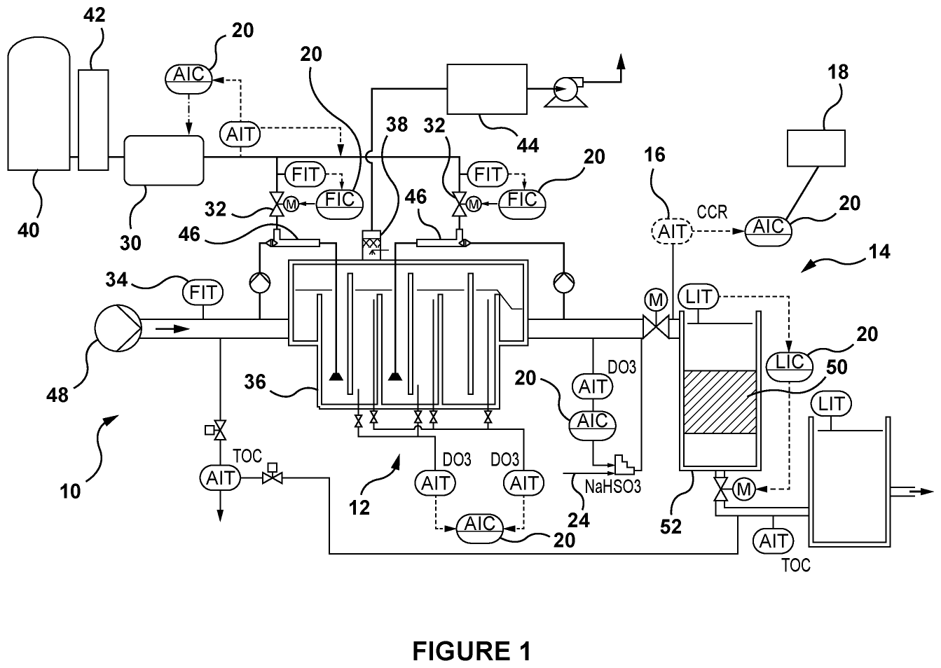

FIG. 1 shows a water treatment system 10 having an ozone contact unit 12 and a biologically active filter 14. The ozone contact unit 12 includes a liquid oxygen tank 40, oxygen vaporizer 42, ozone generator 30, ozone flow control valves 32, contact tank 36, defoaming system 38, ozone destruction unit 44, for example a catalytic ozone destruction unit, and ozone bubble generators 46. Wastewater 48 flows into and through the contact tank 36. Ozone dissolves into the wastewater 48 and reacts with organic compounds in the wastewater 48. After being treated by ozonation, the wastewater flows from the contact tank 36 to a reactor 52 of the biologically active filter 14. The reactor 50 in this example contains a media bed 50 coated with a biofilm. Bacteria in the biofilm biodegrade the ozonated organic compounds in the wastewater.

A bio-electrochemical sensor 16 is provided in communication with water flowing between the ozone contact unit 12 and the biologically active filter 14. The bio-electrochemical sensor 16 is connected to a controller 18. The bio-electrochemical sensor 16 is downstream of a sodium bisulfite injection 24. As shown, the controller 18 is connected only to a local controller 20 of the bio-electrochemical sensor. This allows, for example, display of measurements from the bio-electrochemical sensor to a system operator. The system operator may adjust the operation of the ozone contact unit 12 or the biologically active filter 14 based on the displayed measurements or based on further calculations or recommendations provided by the controller 18. Optionally, controller 18 is also connected to one or more other local controllers in the system 10. For example, the controller 18 may be connected to one or more local controllers 20 associated with the ozone generator 30, or ozone flow control valves 32, or both. The controller 18 may be configured to control the amount of ozone delivered to the water based on a signal from the bio-electrochemical sensor 16, optionally in combination with signals from one or more other sensors, for example an influent flow sensor 34. Alternatively, or additionally, the controller 18 may be configured to control one or more operating parameters of the biologically active filter 14 based on a signal from the bio-electrochemical sensor 16, optionally in combination with signals from one or more other sensors.

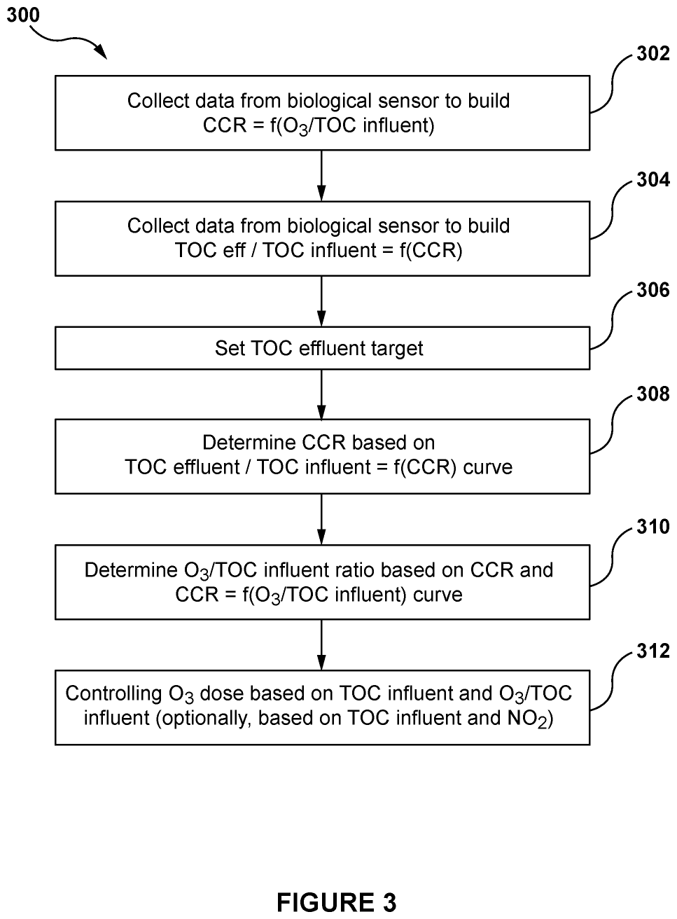

FIG. 3 illustrates an example method 300 using one or more biological sensors to control a wastewater treatment plant, optionally including collecting data for generating relationships (i.e. mathematical functions) used in an ozone generation control algorithm. In a preliminary step, a plant may be started up allowing about one month for the biological sensor to acclimate in the plant environment. The biological sensor may then be used to collect data to determine a relationship (step 302) based on metabolic activity (i.e. CCR) measured over a range of O3 and influent TOC conditions, for example, a curve (i.e. function) of CCR=f(O3/TOC). A relationship comparing TOC removal (i.e a ratio or difference between measured influent and effluent TOC) and measured CCR (step 304) may be built in parallel with step 302 or in series. For example, a f(CCR)=TOC effluent/TOC influent curve (i.e. function) may be built. If the BAF media in the system is adsorptive, a wait time of 3-6 months after plant start-up may be required before building the f(CCR)=TOC effluent/TOC influent curve in order to allow for the BAF to transition from being adsorptive to performing the desired biological processes. If the media is not adsorptive, the curve may be built between about 1 and about 6 months from the start-up of the plant. The relationships determined in step 302 and step 304 may then be used in the remainder of the ozone generation control method. For example, a target TOC effluent may be set (step 306), for example based on a discharge regulation. In step 308, a TOC effluent/TOC influent ratio may be calculated using a measurement of TOC influent and the target TOC effluent determined in step 306. Using the curve built in step 304 (or its inverse function) and the TOC effluent/TOC influent ration, a metabolic activity (i.e. CCR) may also be determined in step 308. The curve created in step 302 describes metabolic activity (i.e. CCR) as a function of O3/influent TOC, therefore this ratio (O3/influent TOC) can then be identified in step 310 using the inverse relationship. In the event that more than one ratio of O3/influent TOC corresponds with the metabolic activity i.e. CCR), the lowest ratio is used. From the O3/influent TOC ratio, the amount of O3 dose required may be determined based on the measured influent TOC in step 312. In some examples, the curve in step 302 is generated at a stable NO2 concentration or taking into account influent NO2 concentration since NO2 consumes ozone. For example the relationship in step 302 may be based on ozone net of ozone consumed by NO2. Optionally, O3 determined in step 312 may be determined based on influent TOC and NO2, for example by increasing O3 determined using a relationship based on ozone net of ozone consumed by NO2 by an amount that will be consumed by influent NO2. After step 312, the process may return to step 308 for adjustments to the ozone dose at suitable time intervals, for example once every 10-120 minutes. Optionally, the process may return to step 306 if the TOC effluent target changes, for example due to a regulatory change. Optionally, the process may return to step 302 periodically to update the functions or other relationships described herein.

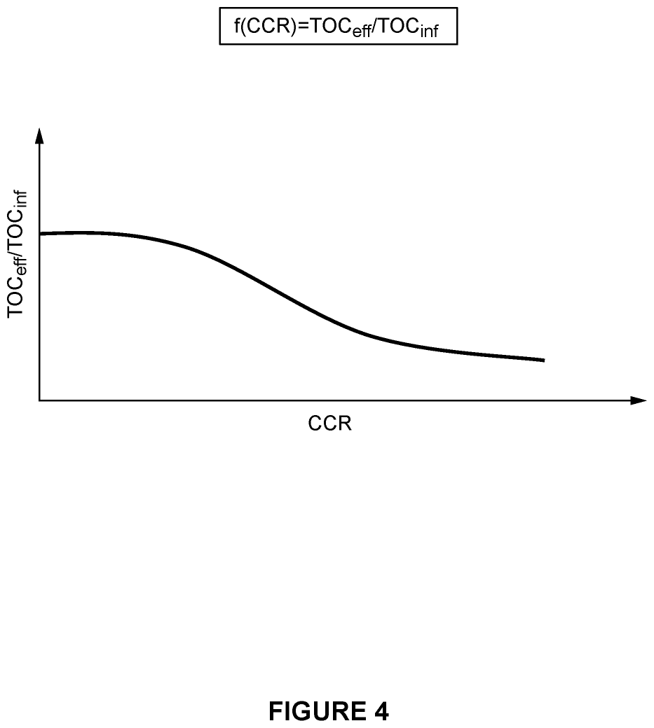

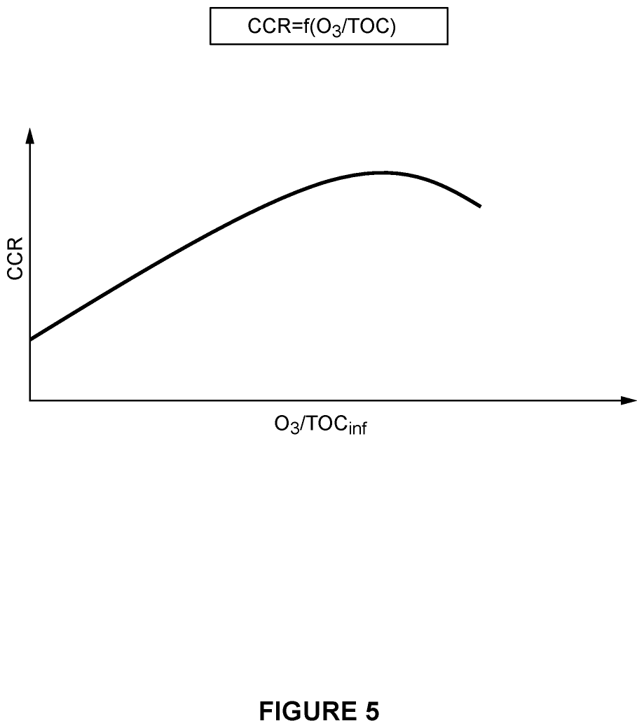

FIG. 4 illustrates a sample curve which may be built in step 304, the curve showing the ratio of TOC effluent/TOC influent as a function of CCR. FIG. 5 illustrates a sample curve which may be built in step 302, the curve showing CCR as a function of the ratio of O3/TOC influent. Each of these curves may be produced using one or more of calculations, modeling, historical data from analogous plants, or historical data from the plant being controlled using the curves. Optionally, the curves will be unique to the plant from which historical data is collected such as to provide an O3 control algorithm specific to the plant.

1. A water treatment system comprising,
an ozonation unit; and,
a biological sensor,
wherein the biological sensor is in contact with effluent from the ozonation unit and adapted to measure the growth or metabolism of microorganisms associated with the biological sensor.

2. The system of claim 1, wherein the biological sensor measures the extent to which organic contaminants in the effluent from the ozonation unit are biodegradable.

3. The system of claim 1, wherein the biological sensor produces or enables a measurement or signal related to carbon consumption rate (CCR) or carbon bio-degradation (CBD) of a population of bacteria associated with the biological sensor.

4. The system of claim 1 wherein the biological sensor is a bio-electrochemical sensor that produces an electrical signal related to the metabolic activity of bacteria on an electrode of the sensor.

5. The system of claim 4 wherein the bio-electrochemical sensor comprises a power unit to deliver a voltage or current across an electrode pair of the biosensor.

6. The system of claim 1 wherein the biological sensor is connected to a controller adapted to adjust an operating parameter of the ozonation unit.

7. The system of claim 1 comprising a biological treatment unit downstream of the ozonation unit.

8. The system of claim 7 wherein the biological treatment unit is a biologically active filter.

9. The system of claim 7 wherein the biological sensor is connected to a controller adapted to adjust an operating parameter of the biological treatment unit.

10. The system of claim 1 connected to the outlet of a secondary or tertiary treatment unit of a municipal or industrial wastewater treatment plant.

11. A method of treating water, or a method of controlling a water treatment process, comprising,
contacting the water with ozone to produce an ozonated effluent; and,
contacting the ozonated effluent with a biological sensor.

12. The method of claim 11 wherein the biological sensor measures the extent to which organic contaminants in the ozonated effluent are biodegradable.

13. The method of claim 12 wherein the biological sensor measures the metabolic activity, optionally the carbon consumption rate, of organisms exposed to the ozonated effluent.

14. The method of claim 13 wherein the biological sensor is a bio-electrochemical sensor that provides an electrical signal corresponding to the metabolic activity of a population of bacteria on an electrode of the biosensor.

15. The method of claim 14 comprising applying a voltage or current across an electrode pair of the biosensor.

16. The method of claim 11 wherein a measurement or signal from the biosensor is used to adjust the rate of ozone delivery to the wastewater.

17. The method of claim 11 comprising biological degradation of contaminants of the ozonated effluent.

18. The method of claim 17 wherein the biological degradation occurs in a biologically active filter.

19. The method of claim 17 wherein the measurement or signal from the biosensor may be used to adjust an operating parameter of the biological degradation treatment step.

20. The method of claim 11 wherein the water is secondary or tertiary effluent from a municipal or industrial wastewater treatment plant.

21. A method of operating a wastewater treatment system comprising an ozone contactor and a biologically active filter, the method comprising,
setting a total organic carbon (TOC) effluent target;
collecting metabolic activity data from one or more biological sensors positioned downstream of the ozone contactor;
collecting TOC influent data;
determining a target ozone amount considering the metabolic activity data, the TOC influent data and the TOC effluent target;
controlling ozone injection into the ozone contactor according to the target ozone amount.

22. The method of claim 21 comprising,
determining a first relationship between (a) metabolic activity and (b) a comparison, for example a ratio or difference, of TOC effluent to TOC influent for the wastewater treatment system or an analogous system;
determining a second relationship between (a) a ratio of ozone amount to TOC influent and (b) metabolic activity for the wastewater treatment system or an analogous system; and,
determining the target ozone amount considering the first relationship and the second relationship.

23. The method of claim 22 comprising determining a desired metabolic activity considering the first relationship, the TOC effluent target and the TOC influent data.

24. The method of claim 23 comprising determining a desired ratio of ozone amount to TOC influent considering the desired metabolic activity and the second relationship.

25. The method of claim 22 comprising generating the first relationship and/or the second relationship using historical data collected while operating the wastewater treatment plant.

26. The method of claim 25 comprising collecting the historical data during a first one to six months of operation of the wastewater treatment system.

27. The method of claim 23 comprising determining the first relationship at a stable influent NO2 concentration or determining the first relationship taking into account the NO2 concentration in influent to the wastewater treatment system.

28. The method of claim 27 comprising adjusting the target ozone amount based on the influent NO2 concentration.
